(19) United States
(12) Patent Application Publication
(10) Pub. No.: US 2021/0324973 A1
(43) Pub. Date: Oct. 21, 2021

(54) SUPPORT DEVICES FOR DROP CABLES

(71) Applicant: AFL Telecommunications LLC, Duncan, SC (US)

(72) Inventors: Steven Kranz, Moore, SC (US); Samuel Berry, Greer, SC (US)

(21) Appl. No.: 17/221,446

(22) Filed: Apr. 2, 2021

Related U.S. Application Data
(60) Provisional application No. 63/011,606, filed on Apr. 17, 2020.

(51) Int. Cl. F16L 3/23; F16L 3/10; H02G 3/04; H02G 3/22

(52) U.S. Cl. CPC F16L 3/23; F16L 3/1075; H02G 3/0418; H02G 3/22; H02G 3/0456

(57) ABSTRACT

A cable support device includes a body having an inner surface defining a body groove extending longitudinally from a first end to an opposite end of the body, the body further including a first bracket. The cable support device further includes a cap having an inner surface defining a cap groove extending longitudinally from a first end to an opposite end of the cap, the cap further including a first hinge. The cable support device further includes an inner bushing seated in at least one of the body groove or the cap groove, the inner bushing extending along a longitudinal axis between a first end and a second end and defining a length, the inner bushing further defining a plurality of slots, each of the plurality of slots extending between the first end and the second end and configured to accept one of the plurality of cables.

The present application claims priority to U.S. Provisional Patent Application No. 63/011,606, filed Apr. 17, 2020, the disclosure of which is incorporated by reference herein in its entirety.

### FIELD OF THE INVENTION

The present disclosure relates generally to support devices, also known as trunnion clamps, for stringing and supporting cables to poles, towers and other suitable support structures.

### BACKGROUND OF THE INVENTION

Fiber optic cables are widely used for data transmission and require careful handling because of the fragile optical fibers being carried and protected by such cables. These cables are suspended from support structures via support devices and are subject to various dynamic and static stresses that must be controlled. Static stress is caused primarily because the cable is suspended only at longitudinally distanced points while dynamic stress is caused mainly by oscillation of the cable. This oscillation, generally resulting from wind, ice and varying temperatures affecting tension of the cable can damage the cable and associated fibers. Many support devices do not adequately control the effect that stresses have on the cable. For instance, the support device must permit a limited amount of oscillation but not so much as to cause damage to the fibers.

Nor do many of the support devices facilitate ease of stringing the cable. Along with supporting the cable, the device must accommodate the required sag of the cable between support structures. Also, the device must allow cable to slip before fiber damage occurs, yet maintain the cable to required installation tensions. Typically the devices require disassembly, have many parts and do not reassemble easily. As the cables are strung and repaired in the field where non-optimal conditions are almost a certainty, a device that allows for quick and easy stringing of the cable is desired.

Further, many of the support devices do not easily attach to the designated support structure.

Still further, many support devices are only designed to accommodate a single cable. Support devices which accommodate multiple cables can require the use of a considerable number of parts, and can be complicated and expensive to implement. For example, some such support devices can require a penetration into a pole or tower, but such penetrations must be spaced apart from each other (such as by 4 to 6 inches). Accordingly, either larger poles or towers must be utilized for increased numbers of cables, causing increases in construction costs, or the number of cables utilized must be limited.

Still further, the use of multiple cables extending from a support device, while desirable for providing increased network access, can lead to undesirable results. For example, high winds and other external forces can cause the cables to contact each other, leading to cable jacket damage and tangling as well as poor cable aesthetics.

Accordingly, improved cable support devices would be desired. In particular, cable support devices which address various of the above-described issues would be advantageous. Specifically, cable support devices which accommodate multiple cables while also addressing various other of the above-described issues would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment, a cable support device for a plurality of aerial cables is provided. The cable support device includes a body having an inner surface defining a body groove extending longitudinally from a first end to an opposite end of the body, the body further including a first bracket. The cable support device further includes a cap having an inner surface defining a cap groove extending longitudinally from a first end to an opposite end of the cap, the cap further including a first hinge. The cable support device further includes an inner bushing seated in at least one of the body groove or the cap groove, the inner bushing extending along a longitudinal axis between a first end and a second end and defining a length, the inner bushing further defining a plurality of slots, each of the plurality of slots extending between the first end and the second end and configured to accept one of the plurality of cables.

In exemplary embodiments, the cable support device further includes an outer bushing seated in the at least one of the body groove or the cap groove, wherein the inner bushing is seated in the outer bushing.

In accordance with another embodiment, a cable support device for a plurality of aerial cables is provided. The cable support device includes a body having an inner surface defining a body groove extending longitudinally from a first end to an opposite end of the body, the body further including a first bracket. The cable support device further includes a cap having an inner surface defining a cap groove extending longitudinally from a first end to an opposite end of the cap, the cap further including a first hinge. The cable support device further includes a transition piece disposed between the body and the cap, the transition piece including an integrally formed body portion and oppositely-facing cap portion. The body portion has an inner surface defining a body portion groove extending longitudinally from a first end to an opposite end of the body portion, and further includes a second bracket. The cap portion has an inner surface defining a cap portion groove extending longitudinally from a first end to an opposite end of the cap portion, and further includes a second hinge. The first bracket and second hinge form a first hinge mechanism for connecting and aligning the body and the cap portion such that the body groove and the cap portion groove define a first channel. The second bracket and first hinge form a second hinge mechanism for connecting and aligning the body portion and the cap such that the body portion groove and the cap groove define a second channel. The cable support device further includes a plurality of inner bushings, each of the plurality of inner bushings seated in one of the first channel or second channel, each of the plurality of inner bushings extending along a longitudinal axis between a first end and a second end and defining a length, each of the plurality of inner bushings further defining a plurality of slots, each of the plurality of slots extending between the first end and the second end and configured to accept one of the plurality of cables.

In exemplary embodiments, the cable support device further includes a plurality of outer bushings, each of the plurality of outer bushings seated in one of the first channel or second channel, each of the plurality of inner bushings seated in one of the outer bushings.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic illustration of a known fiber optic communications network;

FIG. 2 is an exploded perspective view of a cable support device receiving a cable in accordance with embodiments of the present disclosure;

FIG. 3 is a perspective view of the body of a support device without a body bushing in accordance with embodiments of the present disclosure;

FIG. 4 is a perspective view of the cap of a support device without a cap bushing in accordance with embodiments of the present disclosure;

FIG. 5 is a perspective view of an assembled support device, including the bushings, in its open position in accordance with embodiments of the present disclosure;

FIG. 6 is a perspective view of an assembled support device, including the bushings, in its closed position in accordance with embodiments of the present disclosure;

FIG. 7a is a side view of a support device affixed to a support structure via a bolt in accordance with embodiments of the present disclosure;

FIG. 7b is a side view of a support device banded to a support structure in accordance with embodiments of the present disclosure;

FIG. 8 is a side view of a support device, including a transition piece, banded to a support structure in accordance with embodiments of the present disclosure;

FIG. 9 is a perspective view of a support device, including a transition piece, in accordance with embodiments of the present disclosure;

FIG. 10 is a perspective disassembled view of a support device, including a transition piece, in accordance with embodiments of the present disclosure;

FIG. 11 is a perspective view of a transition piece of a support device in accordance with embodiments of the present disclosure;

FIG. 12 is a perspective view of an inner bushing of a support device in accordance with embodiments of the present disclosure; and

FIG. 13 is a cross-sectional view of a cable in accordance with embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, the terms “upstream” (or “forward”) and “downstream” (or “aft”) refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component. terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

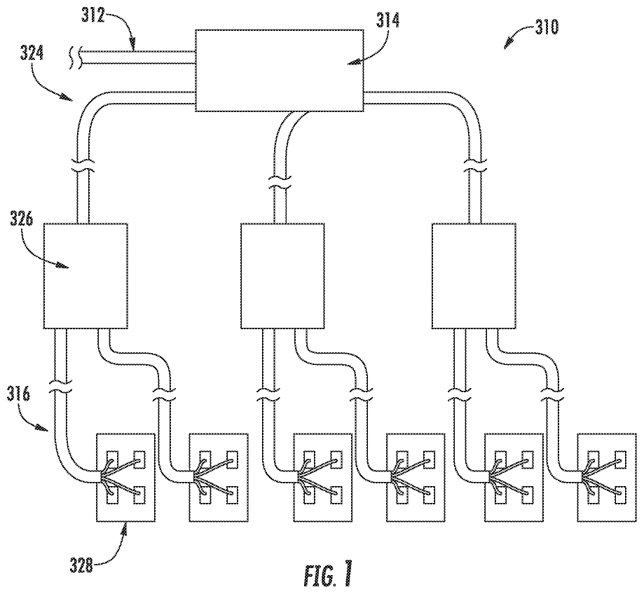

Referring now to FIG. 1, a portion of a known fiber optic communications network 310 which includes a fiber optic distribution cable 312 is shown. One or more mid-span access locations are provided along the length of the distribution cable 312. The mid-span access location may be enclosed and protected from exposure to the environment by a conventional closure 314. The fiber optic communications network 310 may include a fiber optic distribution cable 312 having a plurality of mid-span access locations at branch points spaced along the length of the distribution cable, each providing access to at least one, and preferably, a plurality of optical fibers of the fiber optic network. Thus, in the embodiments shown, the distribution cable 312 may provide multiple locations for joining stub cables 324 of multi-port optical connection terminals 326 to the distribution cable 312 at each mid-span access location.

In the fiber optic network 10 as illustrated, pre-terminated optical fibers of the distribution cable 312 provided at the mid-span access location are routed out of the distribution cable and spliced to respective optical fibers of a stub cable 324 extending from a multi-port optical connection terminal 326. The optical fibers of the stub cable 324 may enter the closure 314 through a suitable cable port provided through an exterior wall, for example an end wall, of the closure 314. The stub cable 324 includes at least one, and preferably a plurality of optical fibers disposed within a protective cable sheath. The stub cable 324 may, for example, be any known fiber optic cable which includes at least one optical fiber and having a fiber count equal to or greater than that of a drop cable 316 to be connected to the multi-port optical connection terminal 326 and equal to or less than that of the distribution cable 312.

The stub cable 324 may extend from the closure 314 into a terminal 326. The optical fibers of the stub cable 324 within the terminal 326 may be connectorized. One or more connectorized drop cables 316 may be interconnected with the connectorized optical fibers of the stub cable 324, i.e. in terminal 326. The drop cables 316 may include at least one single mode or multimode optical fiber of any type optically connected to a single fiber or multi-fiber optical connector in a conventional manner. The other ends of the drop cables 316 are optically connected to respective optical fibers of the communications network within an outside plant connection terminal 328 at a delivery point, such as an outside plant network access point (NAP) closure, local convergence cabinet (LCC), terminal, pedestal or network interface device (NID). As shown, one or more stub cables 324 extends from the closure 314 to a terminal 326 positioned at a distance from the mid-span access location, such as a telephone pole, hand-hole, vault or pedestal (not shown) in the fiber optic network 310. Each drop cable 316 extends from a terminal 326 to another terminal 326 or to an outside plant connection terminal 328 located at a delivery point such as a subscriber home.

It should be understood that the present disclosure is not limited to the above-described embodiment of a fiber optic network 310, and rather that any suitable fiber optic network 310 or other suitable communications network is within the scope and spirit of the present disclosure.

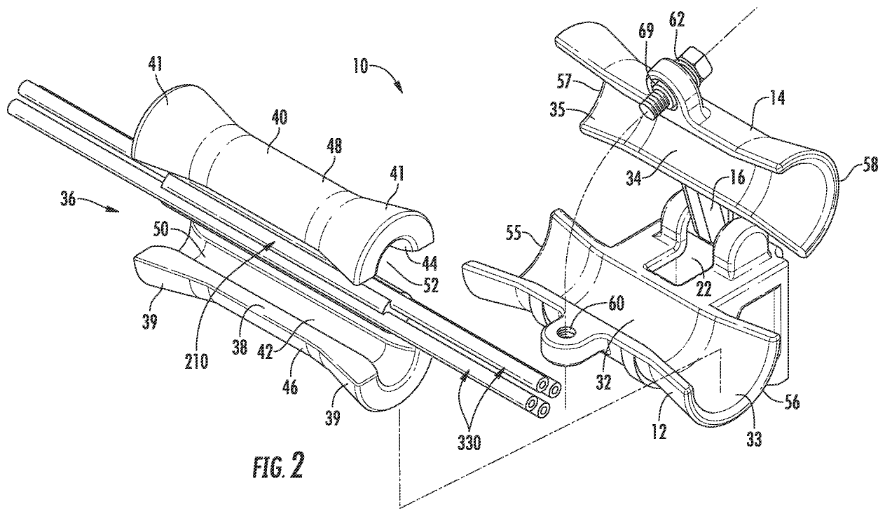

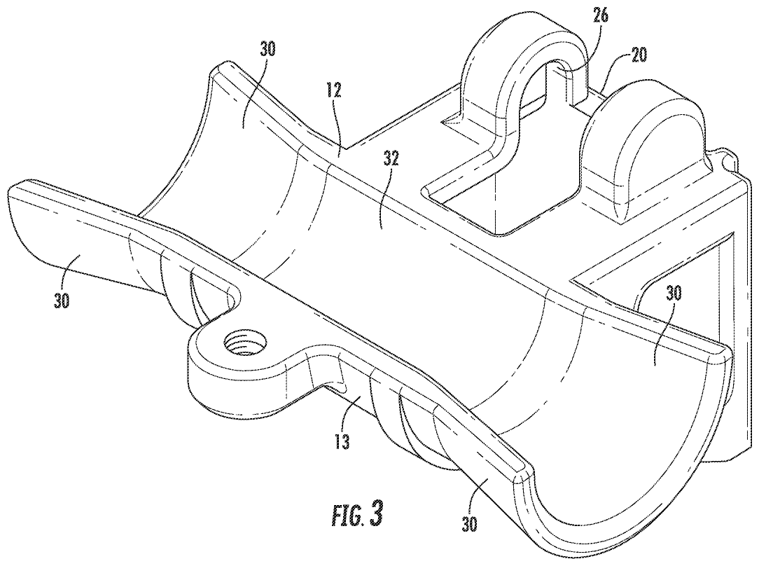

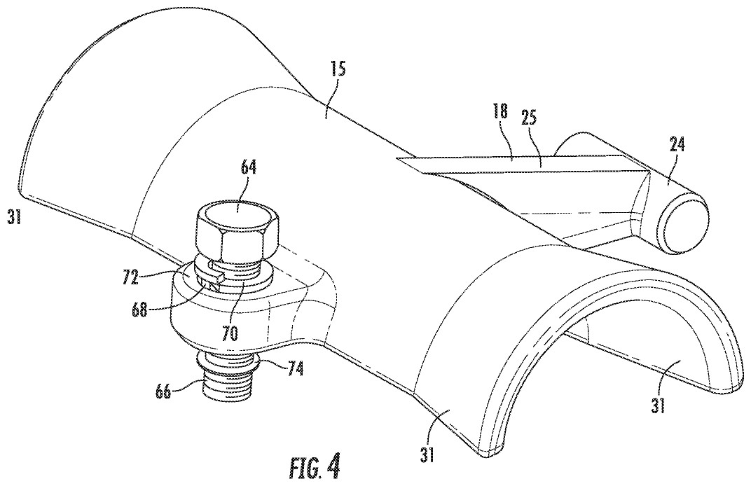

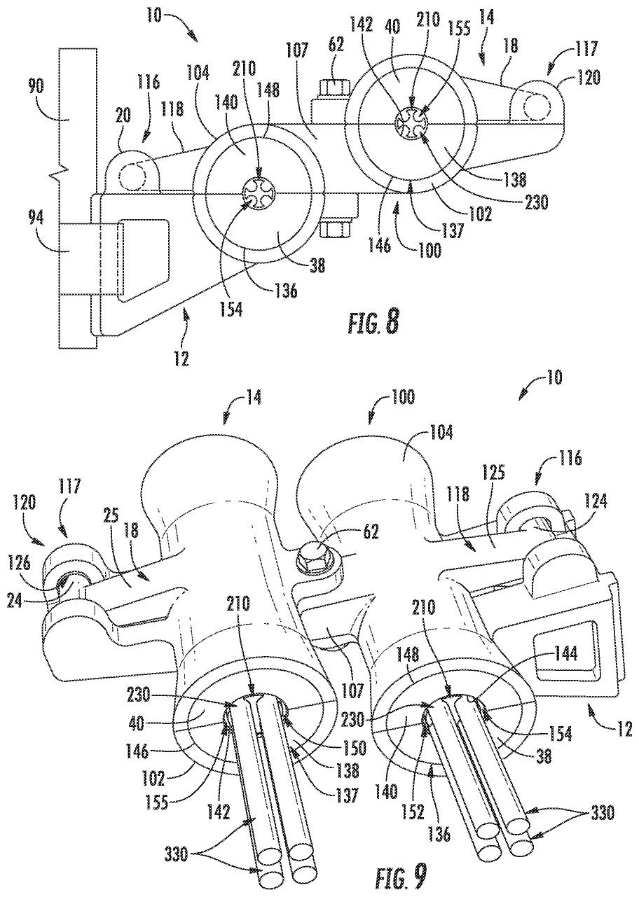

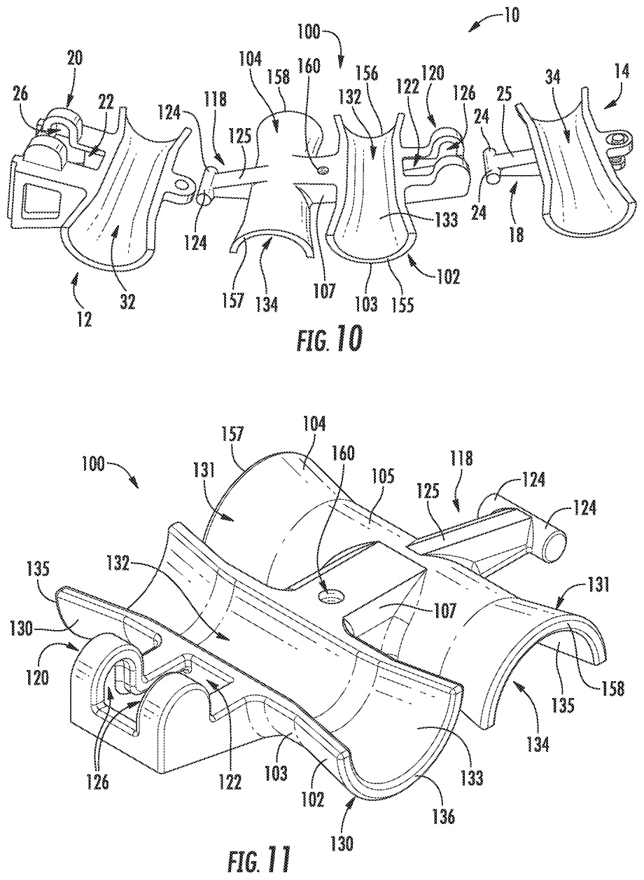

Referring now briefly to FIG. 13, a cable 330 in accordance with embodiments of the present disclosure is illustrated. Cable 330 may, in exemplary embodiments, be utilized as a stub cable 324 and/or drop cable 316. As shown, cable 330 may include a plurality of optical fibers 340 disposed within a buffer tube 342. In some embodiments, a gel may be provided in the buffer tube 342 surrounding the optical fibers 340. Cable 330 may further include strength members 344, which in exemplary embodiments may be water blocking dielectric strength members. A water blocking thread 346 may additionally be provided in the cable 330. A jacket 348 may surround the strength members 344, buffer tube 342 and water blocking thread 346. The jacket 348 may, for example, be formed from a UV resistant material. The jacket 348 may include and form an outermost layer and exterior surface of the cable 330. In some embodiments as shown, the cable 330 generally, and thus the jacket 348 thereof, may have an oval-shaped cross-sectional profile. Accordingly, the cross-sectional profile may have a major radius and a minor radius which are not equal (with the major radius being greater than the minor radius), as opposed to a circular cross-sectional profile which has a constant radius. Such cable 330 may be termed a “flat drop” cable. Alternatively, cable 330 may have a circular cross-sectional profile. It should be understood that the present disclosure is not limited to the above-disclosed flat drop or drop cable embodiments, and rather that the use of any suitable cable 330 (whether fiber optic, electric, or otherwise) is within the scope and spirit of the present disclosure. Referring now to FIGS. 2 through 12, embodiments of cable support devices 10 in accordance with embodiments of the present disclosure are provided. Such devices 10 may advantageously collect and secure a plurality of cables 330, such as aerial cables as discussed herein. The consolidated cables may advantageously be at reduced or eliminated risk of damage via contact with each other or tangling due to use of devices 10, as the devices 10 may position the cables 330 in a secure manner relative to one. Further, use of such devices may advantageously improve the aesthetics of the multiple aerial cables 330 by grouping such cables 330 close together in a secure manner. Still further, use of such devices 10 reduces the risk of ice accumulation and loading on individual cables 330, instead facilitating shared loading and ice weight distribution by multiple cables 330 such that the damage risk is reduced.

Referring now to FIGS. 2 through 6, embodiments of a cable support device 10, also known as a trunnion clamp, are illustrated. The cable support device 10 includes a body 12 and a corresponding cap 14. Body 12 and cap 14 mate via a hinge mechanism 16 that is preferably die cast or sand cast as a portion of both body 12 and cap 14. Hinge mechanism 16 may, for example, include hinge 18 and bracket 20. Hinge 18 may be a component of cap 14, and in exemplary embodiments is integrally formed as part of cap 14 such that cap 14 is a singular, unitary component. Hinge 18 may mate with bracket 20. Bracket 20 may be a component of body 12, and in exemplary embodiments is integrally formed as part of body 12 such that the body 12 is a singular, unitary component.

As shown, hinge 18 may include opposing wings 24 extending generally transversely from a central hinge shaft 25. Bracket 20 may include a slot 22 which is defined in the body 12, and may further include opposing groove slots 26 extending generally transversely from the slot 22. To mate cap 14 and body 12, cap 14 may in some embodiments be rotated approximately 90 degrees from its upright position, and hinge 18 may be inserted into slot 22 of bracket 20. Cap 14 may then be rotated back to its upright position so that wings 24 of hinge 18 slide into groove slots 26 of bracket 20. In other embodiments, slot 22 may be wide enough to accommodate the wings 24, such that no rotation is necessary. In these embodiments, hinge 18 may simply be inserted into slot 22 and translated such that wings 24 slide into groove slots 26, with no rotation necessary. By aligning wings 24 and groove slots 26, body 12 and cap 14 are properly mated. Once mated, body 12 and cap 14 do not need to be completely separated during installation, or when receiving cable 28. Device 10, however, can be disassembled without tools and parts of the device can be replaced if needed.

Body 12 and cap 14 may define body groove 32 and cap groove 34, respectively. Body groove 32 extends longitudinally from first end 55 to the opposite end 56 of arcuate portion 13 of body 12 while cap groove 34 extends longitudinally from first end 57 to opposite end 58 of arcuate portion 15 of cap 14. Body groove 32 and cap groove 34 are provided by the u-shaped inner surfaces 33 and 35 of arcuate portion 13 of body 12 and arcuate portion 15 of cap 14 respectively. When body 12 and cap 14 are aligned and mated, body groove 32 and cap groove 34 create channel 36.

In exemplary embodiments, one or more of the body groove 32 or cap groove 34, such as in some embodiments the channel 36, may include an outer bushing seated therein. Outer bushing may include a body bushing 38 and cap bushing 40, which may be separate components or a single, unitary component. Body groove 32 and cap groove 34 may further receive body bushing 38 and cap bushing 40, respectively, for encompassing, gripping and cushioning cable 28.

Body bushing 38 and cap bushing 40 have inner surfaces 42 and 44 and outer surfaces 46 and 48 respectively. The outer surfaces 46 and 48 of body bushing 38 and cap bushing 40 are arcuate and sized to snugly mate with u-shaped inner surfaces 33 and 35 of body 12 and cap 14. Inner surfaces 42 and 44 of body bushing 38 and cap bushing 40 are each provided with central grooves 50 and 52, respectively. When bushings 38 and 40 are placed in grooves 32 and 34 and body 12 and cap 14 are mated, body bushing groove 50 and cap bushing groove 52 form bushing channel 54

Bushings 38 and 40 are, in exemplary embodiments, made of an elastomer material, preferably a compliant material such as ethylene propylene diene monomer (“EPDM”) rubber made for outdoor applications. The elastomer material provides excellent slip strength and is able to hold the cable to acceptable slip loads of at least 400 pounds without causing attenuation to the optical fibers. Further, in exemplary embodiments, the elastomer material may have a dielectric constant that is close to the dielectric constant of an all-dielectric self-supporting (“ADSS”) cable jacket which is of the type of cable generally strung using a trunnion as described herein. Closely matching these dielectric constants helps to minimize leakage current resulting from electric charge build up, such as that caused by the cable's close proximity to power cables. Such an electric discharge will eventually degrade the cable at the bushing interface.

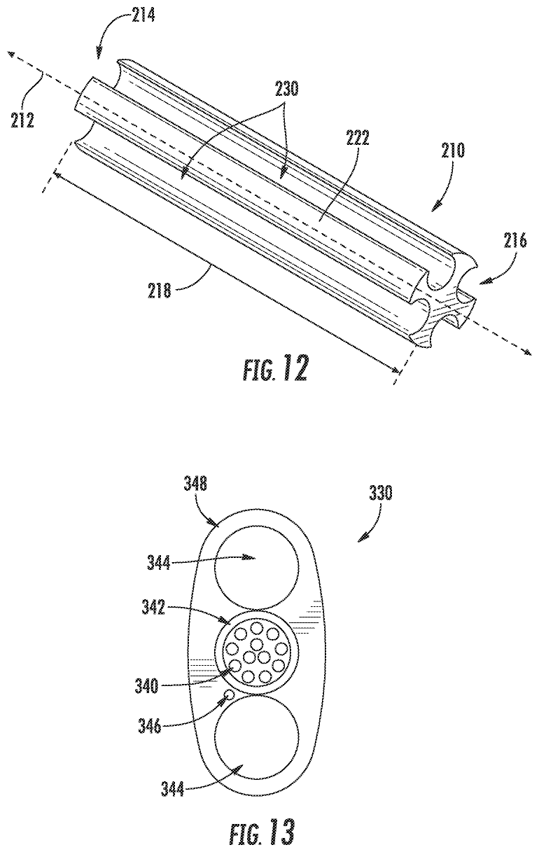

Further, in exemplary embodiments, one or more of the body groove 32 or cap groove 34, such as in some embodiments the channel 36, may include an inner bushing 210 seated therein. In some embodiments, inner bushing 210 may directly contact the body groove 32 and/or cap groove 34 inner surface, such as the channel 36 inner surface. In these embodiments, no outer bushing is needed. Alternatively, in exemplary embodiments as shown, the inner bushing 210 may directly contact the outer bushing, such as the inner surface of the bushing channel 54. Inner bushing 210 may directly secure therein the cables 330 of a plurality of cables 330 (such as aerial cables 330) being consolidated. As shown, and referring now also to FIG. 12, an inner bushing 210 may extend along a longitudinal axis 212 between a first end 214 and a second end 216. A length 218, e.g. a maximum length 218 between the first end 214 and second end 216, may be defined along the longitudinal axis 212 for the inner bushing 210.

In exemplary embodiments, inner bushing 210 may have a generally circular cross-sectional shape, as illustrated. Alternatively, however, other suitable shapes may be utilized. For example, inner bushing 210 may have an oval cross-sectional shape, triangular cross-sectional shape, rectangular cross-sectional shape, or other suitable polygonal cross-sectional shape. In exemplary embodiments, the exterior surface 222 of bushing 110 may be arcuate and sized and shaped to snugly mate with the inner surface with which the bushing 110 has direct contact.

A plurality of slots 220 may be defined in the inner bushing 210. The plurality of slots 220 may each be configured to accept one or more of a plurality of cables 330. Each slot 220 may be an external slot 220 which is defined through an exterior surface 222 of the inner bushing 210. Further, each slot 220 may be defined in and extend through the first end 214 and second end 216. In particular, each slot 220 may extend between the first end 214 and second end 216, such as along the longitudinal axis 212.

Any suitable number of slots 220 may be included in an inner bushing 210. For example, in exemplary embodiments, three or more, such as four, slots 220 may be utilized. Further, in exemplary embodiments, the slots 220 may be equally spaced apart about a perimeter of the inner bushing 210, such as in some embodiments in an annular array.

In exemplary embodiments, the inner bushing 210 is formed from a polymer, such as an elastomer. For example, inner bushing 210 may in exemplary embodiments be formed from a synthetic rubber, such as an ethylene propylene diene monomer (“EPDM”) rubber. Alternatively, another suitable polymer for the inner bushing 210 is polyvinyl chloride (“PVC”). In still further alternative embodiments, the inner bushing 210 may be formed from a suitable non-polymer material, such as a metal (e.g. extruded aluminum). In exemplary embodiments, the inner bushing 210 is formed such that it is non-abrasive with no sharp edges to reduce the risk of cable 330 damage during use.

As discussed, each slot 220 may be configured to accept one or more of the plurality of cables 330. For example, each slot 220 may have a cross-sectional shape and size which corresponds to the shape and size of a single cable 330 or multiple cables to be inserted within the slot 220. Accordingly, when a cable 330 is inserted into the slot 220, the cable 330 may be partially or fully accommodated by the slot 220 in a generally secure manner and the risk slipping of the cable 330 from the slot 220 may be reduced or prevented. The inner bushing 210 material may further advantageously facilitate secure holding of the cables 330 in the slots 120.

Notably, the use of inner bushing 210 with multiple slots 220 advantageously allows for the device 10 to be utilized with various different numbers of cables 330, and further allows for cables 330 to be added or removed as desired. Each slot 220 need not include a cable 330 for the inner bushing 210 and device 10 generally to be properly installed.

Body 12 and cap 14 may, in exemplary embodiments, have radially and axially extending flared edges 30 and 31, respectively. In these embodiments, the associated outer bushing and/or inner bushing 210 may also have flared edges, such as flared edges 39, 41 of the outer bushing as shown. These flared edges limit relative axial movement between the bushings and the body and cap. The bushings are additionally held in place by the surface friction created because of the dissimilar materials used for the bushing and the body and cap. That is, in exemplary embodiments, the body and cap have aluminum casting surfaces that are gripped by the elastomer bushings.

Body 12 may include an aperture 60, which in exemplary embodiments in threaded, that is used in conjunction with a fastener such as a bolt 62 to secure cap 14 and body 12 after cable 28 has been placed in bushing channel 54. Cap 14 may include an opening 68, which in exemplary embodiments is non-threaded, that aligns with aperture 60 when cap 14 and body 12 are mated. Prior to installation, as shown by FIGS. 2, 4 and 5, a loosely fitted lock washer 70 may be put onto bolt stem 66. Bolt 62 may be inserted into opening 68 of cap 14, which may cause washer 70 to contact bolt head 64 and the outer surface 72 of opening 68. Also prior to installation, a tightly fitted o-ring 74 may be placed on bolt stem 66. Accordingly, bolt 62 and lock washer 70 may be used in combination to tighten the device about the cable. O-ring 74 may prevent bolt 62 and lock washer 70 from falling out of opening 68 when cap 14 and body 12 are opened during stringing of the cable and final assembly. O-ring 74 is pushed up into the lower enlarged end 69 of opening 68 when bolt 62 is tightened. Devices in accordance with the present disclosure advantageously minimize loose assembly parts in the field. Thus, there are not loose parts, bolts, nuts or the like that have to be carefully retained when the cable 28 is run through bushing channel 54.

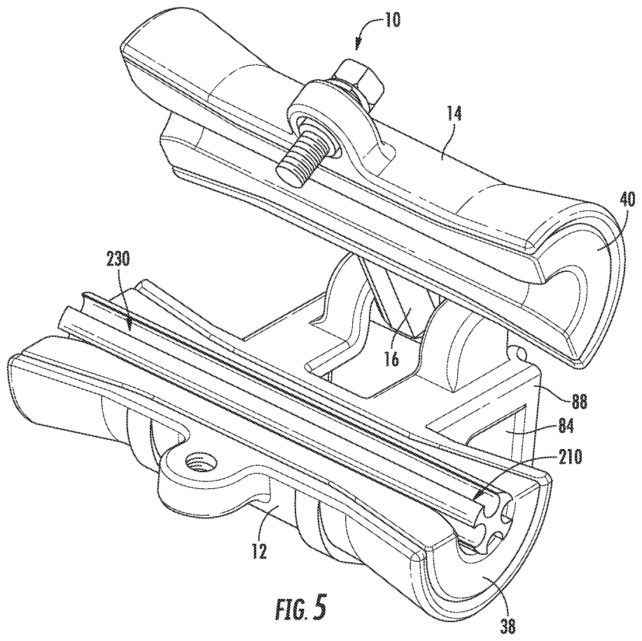

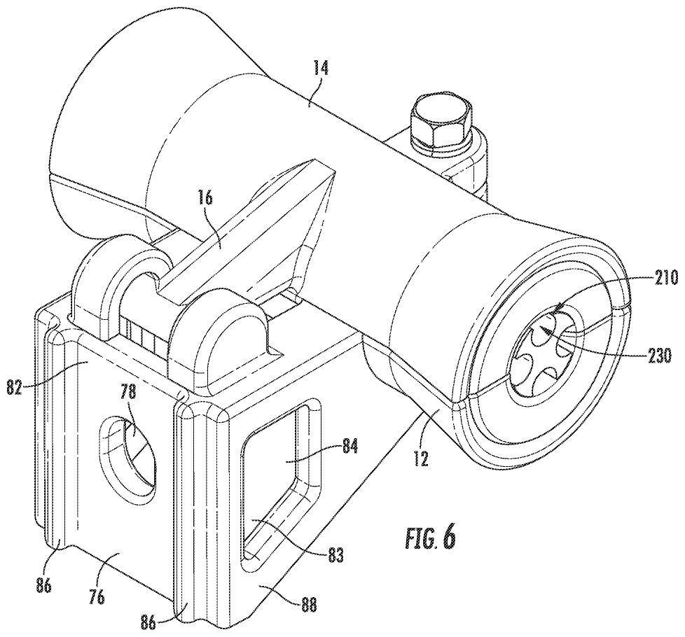

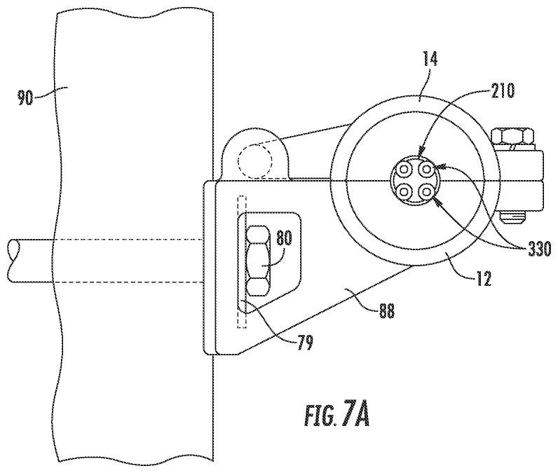

Body 12 may include a securing structure for securing the device 10 to a support structure. For example, securing structure may include mounting surface 76 that has aperture 78 for receiving a mounting bolt 80, as shown in FIGS. 6, 7a and 7b. To install the device 10, the device 10 is properly aligned with support structure 90 and mounting bolt 80 is simply tightened and imbedded into support structure 90 to affix device 10 to support structure 90 as shown in FIG. 7a. A washer, such as a square washer 79, may be used to distribute the force of bolt 80 over the mounting surface. Square washer 79 may also prevent wings 24 of hinge 18 from sliding out of groove slots 26 of bracket 20. That is, when bolt 62 is loosened and cap 14 and body 12 are opened, for example, to receive the bushings during final assembly, cap 14 is held in place by washer 79. Note that the device of this invention is installed without having to thread the device to a bolt or stud protruding from a support structure or rotating the device, which can be quite cumbersome.

It is, however, also possible to secure the device to a support structure using a double arming bolt as is commonly used. When using an arming bolt with devices in accordance with the present disclosure, however, it is not necessary to be overly concerned with how far the bolt extends from the support structure as is often the case with existing designs. The bolt only has to extend through the somewhat thin wall of the body of mounting surface 76 on which aperture 78 is located.

Along with securing the device 10 to a support structure via a fastener such as a bolt, the device 10 can also be secured using banding without the use of a separate adapter as shown in FIG. 7b. Body 12 of device 10 may have side walls 88 extending between mounting surface 76 and arcuate portion 13 of body 12. Banding windows 84 are formed on side walls 88 to receive, for example, a metal banding strip 92 that can be wrapped about the support structure to secure the device, as shown in FIG. 7b. Users may prefer this type of securing method when a concrete or steel support structure is used.

Body 12 of the device 10 may also include anti-rotational legs 86 on outer surface 82 of mounting surface 76. The legs 86 may grip and match the contour of support structure 90. Legs 86 prevent rotation of the device 10 about the support structure, regardless of the material from which the structure is made, including wood, metal or concrete.

Inner surface 83 of mounting surface 76 of body 12 along with side walls 88 are designed to facilitate distribution of the load of cable 28 on the device. Side walls 88 extend partially around arcuate portion 13 of body 12 to help minimize stress and better distribute the load of the cable. Thus, forces are distributed evenly through the device and no areas of high stress are generated by stringing the cable, during final assembly or use of the device.

The body 12 and cap 14 are preferably made of aluminum, such as via a die casting process or sand casting process that provides sufficiently smooth surfaces without further machining or polishing to use the device as a stringing block. The smooth surfaces prevent damage or abrasion to the cable when the device is used without bushings to string cable prior to final assembly. Many current devices require that special polishing processes be used after machining to achieve acceptable surface finishes for the areas of the device that directly contact the cable. Ball burnishing may be used rather than die casting or sand casting to create acceptable cable contacting surfaces.

Devices 10 of the present disclosure are designed to handle cable loading even under extreme weather conditions. The device can easily withstand maximum vertical forces of about 1600 pounds. The device is also able to bear cable loading resulting from wind velocities of 110 mph in a maximum span of 600 feet and can withstand longitudinal unbalanced ice loading. The device also permits greater flexibility than existing support devices to alter the line angle of the cable up to about 22 degrees. Thus, this device is an easily installable, reduced cost, superior functioning cable stringing and support device.

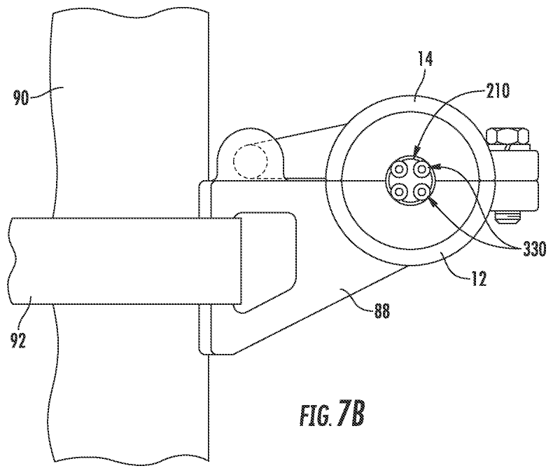

Referring now to FIGS. 8 through 11, additional embodiments of cable support devices 10 in accordance with the present disclosure are provided. As illustrated, such cable support devices 10 may include a body 12 and a cap 14 along with associated outer bushings 38, 40 and/or inner bushing(s) 210. Further such cable support devices 10 may advantageously include a transition piece 100. The transition piece 100 may be positionable generally between the body 12 and the cap 14. When disposed between the body 12 and the cap 14, the transition piece 100 may interface with both the body 12 and the cap 14 to provide support locations for two groups of cables 330s. Accordingly, such devices 10 may advantageously provide expanded capacity while still providing the various advantages discussed above. Additionally, existing cable support devices 10 which include only the body 12 and cap 14 may advantageously be retrofitted to expand their capacity. Notably, all that is required to retrofit an existing support device 10 in accordance with the present disclosure is a transition piece 100 and an additional set of bushings. Accordingly, the number of components required for such expansion is advantageously reduced and simplified.

The transition piece 100 may include a body portion 102 and a cap portion 104. The cap portion 104 may have an oppositely-facing orientation from the body portion 102, as shown. In other words, the body portion 102 may face generally upwards (when appropriately mounted, as conventionally understood) and the cap portion 104 may face generally downwards (when appropriately mounted, as conventionally understood). A bridge 107 may extend between and connect the body portion 102 and cap portion 104. Further, the body portion 102 and cap portion 104 may in exemplary embodiments be integrally formed, such as via die casting or sand casting, such that the transition piece 100 is a singular, unitary component.

Body portion 102 may include a second bracket 120, and cap portion 104 may include a second hinge 118. The first bracket 20 of the body 12 and the second hinge 118 may be mateable to form a first hinge mechanism 116. The second bracket 120 may be mateable with the first hinge 18 of the cap 14 to form a second hinge mechanism 117. The hinge mechanisms 116, 117 are preferably die cast or sand cast as portions of body 12, cap 14 and transition piece 100 (i.e. the body portion 102 and cap portion 104 thereof).

First hinge mechanism 116 may, for example, include first bracket 20 and second hinge 118. Hinge 118 may be a component of cap portion 104, and in exemplary embodiments is integrally formed as part of cap portion 104. Hinge 118 may mate with bracket 20.

As shown, hinge 118 may include opposing wings 124 extending generally transversely from a central hinge shaft 125. To mate cap portion 104 and body 12, cap portion 104 may in some embodiments be rotated approximately 90 degrees from its upright position, and hinge 118 may be inserted into slot 22 of bracket 20. Cap portion 104 may then be rotated back to its upright position so that wings 124 of hinge 118 slide into groove slots 26 of bracket 20. In other embodiments, slot 22 may be wide enough to accommodate the wings 124, such that no rotation is necessary. In these embodiments, hinge 118 may simply be inserted into slot 22 and translated such that wings 124 slide into groove slots 26, with no rotation necessary. By aligning wings 124 and groove slots 26, body 12 and cap portion 104 are properly mated.

Second hinge mechanism 117 may, for example, include second bracket 120 and first hinge 18. Bracket 120 may be a component of body portion 102, and in exemplary embodiments is integrally formed as part of body portion 102 such that the body portion 102 is a singular, unitary component.

As shown, bracket 120 may include a slot 122 which is defined in the body 102, and may further include opposing groove slots 126 extending generally transversely from the slot 122. To mate cap 14 and body portion 102, cap 14 may in some embodiments be rotated approximately 90 degrees from its upright position, and hinge 18 may be inserted into slot 122 of bracket 120. Cap 14 may then be rotated back to its upright position so that wings 24 of hinge 18 slide into groove slots 126 of bracket 120. In other embodiments, slot 122 may be wide enough to accommodate the wings 24, such that no rotation is necessary. In these embodiments, hinge 18 may simply be inserted into slot 122 and translated such that wings 24 slide into groove slots 126, with no rotation necessary. By aligning wings 24 and groove slots 126, body portion 102 and cap 14 are properly mated.

Body portion 102 and cap portion 104 may define body portion groove 132 and cap portion groove 134, respectively. Body portion groove 132 extends longitudinally from first end 155 to the opposite end 156 of arcuate portion 103 of body portion 102 while cap portion groove 134 extends longitudinally from first end 157 to opposite end 158 of arcuate portion 105 of cap 104. Body portion groove 132 and cap portion groove 134 are provided by the u-shaped inner surfaces 133 and 135 of arcuate portion 103 of body portion 102 and arcuate portion 105 of cap portion 104 respectively.

When body 12 and cap portion 104 are aligned and mated, body groove 32 and cap portion groove 134 create first channel 136. Body groove 32 and cap portion groove 134 may further receive body bushing 38 and cap portion bushing 140, respectively, for encompassing, gripping and cushioning a cable 28. When body portion 102 and cap 14 are aligned and mated, body portion groove 132 and cap groove 34 create second channel 137. Body portion groove 132 and cap groove 34 may further receive body portion bushing 138 and cap bushing 40, respectively, for encompassing, gripping and cushioning a cable 28.

In exemplary embodiments, one or more of the body portion groove 132 or cap portion groove 134, such as in some embodiments the first channel 136 and/or second channel 137, may include an outer bushing seated therein. An outer bushing may include a body bushing 38 and cap portion bushing 140, which may be separate components or a single, unitary component, or may include a cap bushing 40 and body portion bushing 138, which may be separate components or a single, unitary component. Body portion bushing 138 and cap portion bushing 140 have inner surfaces 142 and 144 and outer surfaces 146 and 148 respectively. The outer surfaces 146 and 148 of body portion bushing 138 and cap portion bushing 140 are arcuate and sized to snugly mate with u-shaped inner surfaces 133 and 135 of body portion 102 and cap portion 104. Inner surfaces 142 and 144 of body portion bushing 138 and cap portion bushing 140 are each provided with central grooves 150 and 152, respectively. When bushings 38 (or 138) and 140 (or 40) are placed in grooves 32 and 134 and body 12 and cap portion 104 are mated, body bushing groove 50 (or 150) and cap portion bushing groove 152 (or 52) form first bushing channel 154. When bushings 138 (or 38) and 40 (or 140) are placed in grooves 132 and 34 and body portion 102 and cap 14 are mated, body portion bushing groove 150 (or 50) and cap bushing groove 52 (or 152) form second bushing channel 155.

Bushings 138 and 140 are, in exemplary embodiments, made of an elastomer material, preferably a compliant material such as ethylene propylene diene monomer (“EPDM”) rubber made for outdoor applications. The elastomer material provides excellent slip strength and is able to hold the cable to acceptable slip loads of at least 400 pounds without causing attenuation to the optical fibers. Further, in exemplary embodiments, the elastomer material may have a dielectric constant that is close to the dielectric constant of an all-dielectric self-supporting (“ADSS”) cable jacket which is of the type of cable generally strung using a trunnion as described herein. Closely matching these dielectric constants helps to minimize leakage current resulting from electric charge build up, such as that caused by the cable's close proximity to power cables. Such an electric discharge will eventually degrade the cable at the bushing interface.

Further, in exemplary embodiments, one or more of the body groove 32, cap groove 34, body portion groove 132 and/or cap portion groove 134, such as in some embodiments the first channel 136 and/or second channel 137, may include an inner bushing 210 seated therein. In some embodiments, inner bushing 210 may directly contact the body groove 32, cap groove 34, body portion groove 132 and/or cap portion groove 134 inner surface, such as the first channel 136 and/or second channel 137 inner surface. In these embodiments, no outer bushing is needed. Alternatively, in exemplary embodiments as shown, the inner bushing 210 may directly contact the outer bushing, such as the inner surface of the bushing channel(s) 154, 155.

Inner bushing 210 may directly secure therein the cables 330 of a plurality of cables 330 (such as aerial cables 330) being consolidated. As shown, an inner bushing 210 may extend along a longitudinal axis 212 between a first end 214 and a second end 216. A length 218, e.g. a maximum length 218 between the first end 214 and second end 216, may be defined along the longitudinal axis 212 for the inner bushing 210.

In exemplary embodiments, inner bushing 210 may have a generally circular cross-sectional shape, as illustrated. Alternatively, however, other suitable shapes may be utilized. For example, inner bushing 210 may have an oval cross-sectional shape, triangular cross-sectional shape, rectangular cross-sectional shape, or other suitable polygonal cross-sectional shape. In exemplary embodiments, the exterior surface 222 of bushing 110 may be arcuate and sized and shaped to snugly mate with the inner surface with which the bushing 110 has direct contact.

A plurality of slots 220 may be defined in the inner bushing 210. The plurality of slots 220 may each be configured to accept one or more of a plurality of cables 330. Each slot 220 may be an external slot 220 which is defined through an exterior surface 222 of the inner bushing 210. Further, each slot 220 may be defined in and extend through the first end 214 and second end 216. In particular, each slot 220 may extend between the first end 214 and second end 216, such as along the longitudinal axis 212.

Any suitable number of slots 220 may be included in an inner bushing 210. For example, in exemplary embodiments, three or more, such as four, slots 220 may be utilized. Further, in exemplary embodiments, the slots 220 may be equally spaced apart about a perimeter of the inner bushing 210, such as in some embodiments in an annular array.

In exemplary embodiments, the inner bushing 210 is formed from a polymer, such as an elastomer. For example, inner bushing 210 may in exemplary embodiments be formed from a synthetic rubber, such as an ethylene propylene diene monomer (“EPDM”) rubber. Alternatively, another suitable polymer for the inner bushing 210 is polyvinyl chloride (“PVC”). In still further alternative embodiments, the inner bushing 210 may be formed from a suitable non-polymer material, such as a metal (e.g. extruded aluminum). In exemplary embodiments, the inner bushing 210 is formed such that it is non-abrasive with no sharp edges to reduce the risk of cable 330 damage during use.

As discussed, each slot 220 may be configured to accept one or more of the plurality of cables 330. For example, each slot 220 may have a cross-sectional shape and size which corresponds to the shape and size of a single cable 330 or multiple cables to be inserted within the slot 220. Accordingly, when a cable 330 is inserted into the slot 220, the cable 330 may be partially or fully accommodated by the slot 220 in a generally secure manner and the risk slipping of the cable 330 from the slot 220 may be reduced or prevented. The inner bushing 210 material may further advantageously facilitate secure holding of the cables 330 in the slots 120.

Notably, the use of inner bushing 210 with multiple slots 220 advantageously allows for the device 10 to be utilized with various different numbers of cables 330, and further allows for cables 330 to be added or removed as desired. Each slot 220 need not include a cable 330 for the inner bushing 210 and device 10 generally to be properly installed.

Body portion 102 and cap portion 104 may, in exemplary embodiments, have radially and axially extending flared edges 130 and 131, respectively. In these embodiments, the associated outer bushings and/or inner bushings 210 may also have flared edges. These flared edges limit relative axial movement between the bushings and the body portion and cap portion. The bushings are additionally held in place by the surface friction created because of the dissimilar materials used for the bushing and the body portion and cap portion. That is, in exemplary embodiments, the body portion and cap portion have aluminum casting surfaces that are gripped by the elastomer bushings.

Bridge 107 may include an aperture 160, which may be threaded or non-threaded, that is used in conjunction with a fastener such as bolt 62 to secure cap 14, body 12, and transition piece 100 after cables 28 has been placed in bushing channels 154, 155. The aperture 160 may align with aperture 60 and opening 68, and the fastener may be inserted therethrough. Various additional fastening components, such as lock washer 70, o-ring 74, etc., may additionally be utilized, as discussed above. The fastening components may be utilized in a manner as described above, with the additional step of the bolt 62 extending through the aperture 160.

The body portion 102, cap portion 104, and transition piece 100 generally are preferably made of aluminum, such as via a die casting process or sand casting process that provides sufficiently smooth surfaces without further machining or polishing to use the device as a stringing block. The smooth surfaces prevent damage or abrasion to the cables when the device is used without bushings to string cables prior to final assembly. Many current devices require that special polishing processes be used after machining to achieve acceptable surface finishes for the areas of the device that directly contact the cable. Ball burnishing may be used rather than die casting or sand casting to create acceptable cable contacting surfaces.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cable support device for a plurality of aerial cables, the cable support device comprising:
a body having an inner surface defining a body groove extending longitudinally from a first end to an opposite end of the body, the body further comprising a first bracket;
a cap having an inner surface defining a cap groove extending longitudinally from a first end to an opposite end of the cap, the cap further comprising a first hinge; and
an inner bushing seated in at least one of the body groove or the cap groove, the inner bushing extending along a longitudinal axis between a first end and a second end and defining a length, the inner bushing further defining a plurality of slots, each of the plurality of slots extending between the first end and the second end and configured to accept one of the plurality of cables.

2. The cable support device of claim 1, wherein the plurality of slots are equally spaced apart in an annular array.

3. The cable support device of claim 1, wherein the plurality of slots is four slots.

4. The cable support device of claim 1, wherein the inner bushing is formed from an elastomer.

5. The cable support device of claim 1, wherein the inner bushing is formed from a synthetic rubber.

6. The cable support device of claim 1, further comprising an outer bushing seated in the at least one of the body groove or the cap groove, wherein the inner bushing is seated in the outer bushing.

7. The cable support device of claim 6, wherein the outer bushing comprises a body bushing and a cap bushing.

8. The cable support device of claim 1, further comprising a transition piece disposed between the body and the cap, the transition piece comprising an integrally formed body portion and oppositely-facing cap portion, the body portion having an inner surface defining a body portion groove extending longitudinally from a first end to an opposite end of the body portion, the body portion further comprising a second bracket, the cap portion having an inner surface defining a cap portion groove extending longitudinally from a first end to an opposite end of the cap portion, the cap portion further comprising a second hinge,
wherein the first bracket and second hinge form a first hinge mechanism for connecting and aligning the body and the cap portion such that the body groove and the cap portion groove define a first channel, and wherein the second bracket and first hinge form a second hinge mechanism for connecting and aligning the body portion and the cap such that the body portion groove and the cap groove define a second channel.

9. The cable support device of claim 8, wherein the inner bushing is seated in at least one of the first channel or the second channel.

10. The cable support device of claim 1, wherein the first bracket and first hinge form a hinge mechanism for connecting and aligning the body and the cap such that the body groove and the cap groove define a channel.

11. The cable support device of claim 10, wherein the inner bushing is seated in the channel.

12. The cable support device of claim 1, wherein the body and the cap each include flared edges.

13. The cable support device of claim 1, wherein the body further comprises a securing structure, the securing structure comprising a mounting surface defining an aperture.

14. A cable support device for a plurality of aerial cables, the cable support device comprising:
a body having an inner surface defining a body groove extending longitudinally from a first end to an opposite end of the body, the body further comprising a first bracket;
a cap having an inner surface defining a cap groove extending longitudinally from a first end to an opposite end of the cap, the cap further comprising a first hinge;
a transition piece disposed between the body and the cap, the transition piece comprising an integrally formed body portion and oppositely-facing cap portion, the body portion having an inner surface defining a body portion groove extending longitudinally from a first end to an opposite end of the body portion, the body portion further comprising a second bracket, the cap portion having an inner surface defining a cap portion groove extending longitudinally from a first end to an opposite end of the cap portion, the cap portion further comprising a second hinge, wherein the first bracket and second hinge form a first hinge mechanism for connecting and aligning the body and the cap portion such that the body groove and the cap portion groove define a first channel, and wherein the second bracket and first hinge form a second hinge mechanism for connecting and aligning the body portion and the cap such that the body portion groove and the cap groove define a second channel; and
a plurality of inner bushings, each of the plurality of inner bushings seated in one of the first channel or second channel, each of the plurality of inner bushings extending along a longitudinal axis between a first end and a second end and defining a length, each of the plurality of inner bushings further defining a plurality of slots, each of the plurality of slots extending between the first end and the second end and configured to accept one of the plurality of cables.

15. The cable support device of claim 12, wherein the plurality of slots are equally spaced apart in an annular array.

16. The cable support device of claim 12, wherein the plurality of slots is four slots.

17. The cable support device of claim 12, wherein the inner bushing is formed from an elastomer.

18. The cable support device of claim 12, wherein the inner bushing is formed from a synthetic rubber.

19. The cable support device of claim 12, further comprising a plurality of outer bushings, each of the plurality of outer bushings seated in one of the first channel or second channel, each of the plurality of inner bushings seated in one of the outer bushings.

20. The cable support device of claim 12, wherein the body further comprises a securing structure, the securing structure comprising a mounting surface defining an aperture.
